(19) United States
(12) Patent Application Publication
(10) Pub. No.: US 2026/0134152 A1
(43) Pub. Date: May 14, 2026

(54) CROSS-SYSTEM RESOURCE AUTHORIZATION USING USER CAPABILITIES

(71) Applicant: Cisco Technology, Inc., San Jose, CA (US)

(72) Inventors: Subramaniam Baskaran, Foster City, CA (US); Abhijit Bhave, Dublin, CA (US); Margaret Kelley, Boulder, CO (US); Michael Margulis, Danville, CA (US); Rehan Salman Mulla, Fremont, CA (US)

(21) Appl. No.: 18/941,615

(22) Filed: Nov. 8, 2024

(51) Int. Cl. G06F 21/62

(52) U.S. Cl. CPC G06F 21/629; G06F 2221/2141

(57) ABSTRACT

Techniques for cross-system resource authorization using user capabilities are disclosed. In an example computer-implemented method, a first system stores capabilities information identifying a set of capabilities configured for a user using a first access management system of the first system. A second system receives a request from the user to perform an action on a resource associated with the second system. The second system identifies the set of one or more capabilities configured for the user using the capabilities information. A second access management system of the second system determines whether the user is authorized to perform the action on the resource based upon the identified set of capabilities configured for the user. Upon determining by the second access management system that the user is authorized to perform the action on the resource, the user is allows to perform the action on the resource.

### FIELD

The present disclosure generally relates to authentication and authorization systems, and more particularly relates to techniques used for cross-system resource authorization using user capabilities.

### BACKGROUND

The ever-increasing complexity of software applications has made it very difficult to quickly diagnose problems when something goes wrong in an application. The increase in complexity is driven by adoption of new architectures, such as distributed microservices-based architectures, and more complex front-end and back-end implementations. Customers and users of these applications are however demanding better performance from these applications and performance problems (e.g., slow responsiveness, errors, down times) with an application can cause to users stop using the application and use an alternative instead. Providers of software applications thus need tools that facilitate performance monitoring of the software applications, early identification of any problems, and quick resolution of any problems.

This has led to increased popularity of observability systems. These systems are configured to facilitate real-time monitoring of software applications and near real-time analysis of the data captured from the monitoring. For example, an observability system configured to monitor the performance of a software application may monitor and receive data related to the execution of the software application, perform near real-time analysis of the received data, generate actionable data, output the analyses results via dashboards, etc.

Such observability systems can be configured as adjuncts to other systems. For example, an observability system can be used in parallel with a logs analysis system, a web application, a database, and so on. In these configurations, the observability system and its complement system(s) may be tightly integrated. For example, an observability system used in parallel with a logs analysis system may share information about users, monitored systems, configuration data, and other data. In some cases, observability systems can also share services such as authentication services to provide a seamless user experience. In that example, users can authenticate once to a component of the observability system or a complementary system (e.g., a logs analysis system) and thereby obtain security credentials to access both systems.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example of a system for cross-system resource authorization using user capabilities, according to some examples of the present disclosure.

FIG. 2 shows an illustration of a set of users, roles, and capabilities used with some systems for cross-system resource authorization using user capabilities, according to some examples of the present disclosure.

FIG. 3 shows a flowchart of an example method for cross-system resource authorization using user capabilities, according to some examples of the present disclosure.

FIG. 4 shows a flowchart of an example method for determining whether a user is authorized to perform an action on a resource based upon an identified set of capabilities configured for the user, according to some examples of the present disclosure

FIG. 5 shows a flowchart of an example method for updating a memory of a second system by an access management system of a first system, according to some examples of the present disclosure

FIG. 6 shows a flowchart of an example method for configuring authorization for a first system and second system, according to some examples of the present disclosure.

FIG. 7 shows an example of a graphical user interface (“GUI”) for managing users for cross-system resource authorization using user capabilities, according to some examples of the present disclosure.

FIG. 8 shows an example of a GUI for managing roles for cross-system resource authorization using user capabilities, according to some examples of the present disclosure.

FIG. 9 shows an example of a GUI for creating new roles for cross-system resource authorization using user capabilities, according to some examples of the present disclosure.

FIG. 10 shows a flowchart of an example method or managing capabilities information for cross-system resource authorization using user capabilities, according to some examples of the present disclosure.

FIG. 11 illustrates an example of an architecture of a computer that may be used in some systems for cross-system resource authorization using user capabilities, according to some examples of the present disclosure.

### DETAILED DESCRIPTION

Examples are described herein in the context of techniques for cross-system resource authorization using user capabilities. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

The present disclosure generally relates to authentication and authorization systems, and more particularly relates to techniques used for cross-system resource authorization using user capabilities. Certain examples will be discussed in the context of an observability system and a logs analysis system operating together, where the logs analysis system provides some centralized authentication and authorization services to the observability system. In general, the techniques described herein may be applicable in any context in which certain authentication and authorization services are shared between the two systems to provide cross-system resource authorization using user capabilities.

In certain implementations, an observability system may provide a number of services, features, or resources for users of the observability system, collectively referred to herein as “resources.” The resources may be accessible using a user interface (“UI”) provided by the observability system or via an application programming interface (“API”) likewise provided by the observability system. For instance, the resources may include real-time monitoring, logging, alerting, and visualization of monitored system performance and health metrics, and so on.

Access to the resources is generally preceded by an authentication operation. For example, a logs analysis system operating alongside an observability system may include an authentication subsystem that can provide authentication services for both the log analysis and the observability system. In another similar example, both the logs analysis system and the observability system can each include independent components or subsystems for authentication. In both cases, the logs analysis system and the observability system can continue to share data to support various operations.

However, authentication alone is not enough for accessing the resources provided by the observability system. Authentication is related to verifying the client is who they purport to be. Authorization, on the other hand, is related to verifying that the client is allowed to access the resource according to organizational policies, security clearance, job role, and other criteria. A properly authenticated user, for example, may still be unable to use certain resources without the proper authorization.

Authorization to use observability resources is typically configured by administrators of the observability system. Various approaches for configuring authorization to services can be used. In one approach, authorization to use resources can be configured using a number of granular permissions or “capabilities.” For example, consider an example observability resource such as viewing a metric for a particular monitored system (hereinafter the “viewing resource” for these examples). The viewing resource may have associated capabilities such as “view,” “edit,” “delete,” “copy,” and so on. An organizational administrator can associate a particular user with specific capabilities using a suitable UI or API according to certain criteria. To facilitate administrative efficiency, as the number of possible capabilities can quickly grow quite large for an observability system, capabilities can be grouped and then groups of capabilities can be associated with users.

One such grouping is sometimes referred to as a “role.” Roles can refer generally to collections of capabilities (or collections of sets of capabilities) that are grouped together according to a unifying property, such as capabilities that may be needed for a particular job or responsibility. A role may accordingly be named for administrative ease. For instance, an edit capability for the viewing resource may be grouped into an “Editor” role. The Editor role can then be associated with certain users by administrators, thereby granting each user with a collection of capabilities at once. This grouping scheme is an approach for access management sometimes referred to a “role based access control” (“RBAC”). Other grouping schemes, including nested schemes, can be similarly used. In addition to RBAC, the techniques of this disclosure are equally applicable to other authorization schemes that include roles, capabilities, or other comparable abstractions to be associated with users, user devices, digital entities, and so on. For example, other authorization schemes may include attribute-based access control (ABAC), capability-based access control (CBAC), or policy-based access control (PBAC).

In existing systems, the assignment of capabilities and/or roles to observability system users is typically persisted in a data store local to the observability system. For example, the observability system can include a dedicated access management store that includes information about the roles and/or capabilities assigned to individual users, groups, client devices, and so on. When a user attempts to access an observability resource, such as the viewing resource, an authorization subsystem of the observability system queries the local access management store using information about the identity of the user and the resource. In response, the local access management store returns information about the capabilities and/or roles assigned to that user. The authorization subsystem can then determine whether the user is authorized to use the resource in question.

An observability system configured in this way presents a number of challenges to system administrators, particularly when the observability system is operated in parallel with other systems such as a logs analysis system. Maintaining an access management store local to the observability system requires independent administration including manual updates as user roles or capabilities evolve, creating administrative overhead and the potential for outdated or incorrect access permissions. Likewise, because the logs analysis system may include a parallel, distinct set of roles and capabilities, the administrative burden can be further multiplied by the need to maintain parallel access management stores. Maintenance of a local access management store may present a barrier to sharing roles between the parallel systems. For instance, if the same or similar roles are desired to be used for both systems, synchronizing those roles can create another administrative burden. In some examples, as in a cloud services provider context, unique access management stores may need to be instantiated for individual tenants or environments that operate observability system instances, creating a geometrically growing burden that can result in inconsistencies and security vulnerabilities. Furthermore, managing authorization using a local access management store in dynamic environments, where users frequently change roles or require temporary permissions, can add further complexity, as administrators must ensure that roles and capabilities updated across all relevant systems.

These challenges can be addressed using the techniques for cross-system resource authorization using user capabilities disclosed herein. Certain concepts can be illuminated using an illustrative example. Consider an observability system and a logs analysis system. Both the observability system and the logs analysis system can be receiving data from the same monitored systems and in this respect are operating in parallel or alongside each other. The observability system can receive a request for access to an observability system resource, which requires one or more specified capabilities to access, from a user device operated by a user. The user may be authenticated using a remote authentication subsystem that is shared by the observability system and the logs analysis system (e.g., a single sign-on (“SSO”) system).

Capabilities information that identifies a set of capabilities configured for the user can be stored by a component of the logs analysis system such as an access management store or database. After receiving the request, the observability system identifies the set of capabilities configured for the user. For example, the capabilities information may be cached locally at the observability system. For instance, an authorization subsystem of the observability system can query an authorization cache using information about the user such as an identifier like a username or other identifying key. The authorization cache can be populated, periodically or in response to certain triggers, with capabilities information for a number of users that is stored by the logs analysis system. In some cases, the authorization cache may not have the capabilities information about the particular user, or the information may be expired according to a configured cache retention policy. In that case, the logs analysis system can be queried directly by the access management system of the observability system.

The authorization subsystem of the observability system determines whether the user is authorized to perform the action on the resource based upon the identified set of capabilities. Upon determining that the user is authorized to perform the action on the resource the access management system allows the user to perform the action on the resource; otherwise, the user can be prevented from performing the action on the resource. For example, the access management system of the observability system can determine that at least one of the identified capabilities is among the one or more required capabilities for access to the resource and output an indication of an authorization for accessing the resource. This may include, for example, a message indicating that access to the resource has been granted or performance of a service associated with the resource.

Embodiments described in this disclosure provide significant technical improvements in the context of authentication and authorization systems. As described herein, the observability system addresses the aforementioned challenges through the disclosed techniques for cross-system resource authorization using user capabilities. In addition to those improvements, the techniques disclosed also contribute to optimization of the consumption computing resources and network architecture. By offloading certain authorization functions to a remote system, resources that are local to the observability system are freed from the overhead of maintaining and querying local RBAC data, resulting in more efficient memory and CPU usage. Additionally, the use of a remote access management store can reduce latency in authorization checks through the innovative use of the authorization cache, which can also further reduce network traffic.

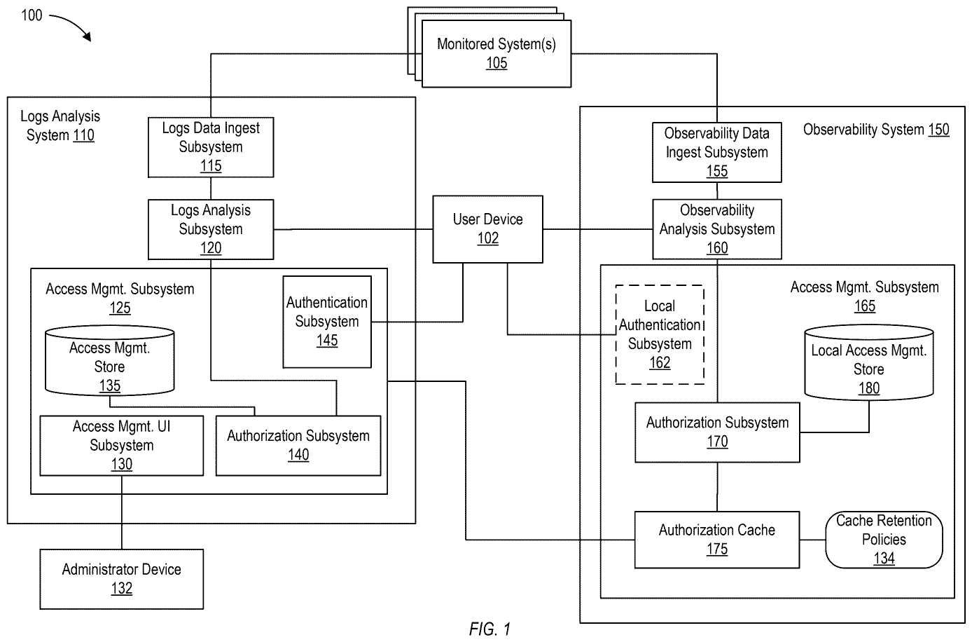

The following sections describe various non-limiting examples and embodiments incorporating the teachings described in this disclosure. Referring first to FIG. 1, FIG. 1 shows an example of a system 100 for cross-system resource authorization using user capabilities, according to some examples of the present disclosure. System 100 includes a logs analysis system 110 and an observability system 150. The logs analysis system 110 can include components for ingesting and processing logged data from various sources. The observability system 150 can include components for real-time monitoring and visualization of data obtained from various sources. In system 100, both the logs analysis system 110 and the observability system 150 are shown as receiving data from monitored systems 105. In various examples, the logs analysis system 110 and the observability system 150 can receive data from different monitored systems 105, the same monitored systems 105, or a combination of both.

The system 100 may be implemented using one or more data processing systems and computing devices. As shown, the observability system 100 comprises multiple systems and subsystems that are communicatively coupled to each. Importantly, system 100 depicted in FIG. 1 is merely an example and is not intended to unduly limit the scope of claimed embodiments. Many variations, alternatives, and modifications are possible. For example, in some implementations, the system 100, including the logs analysis system 110 and the observability system 150, may have more or fewer systems or subsystems than those shown in FIG. 1, may combine two or more systems or subsystems, or may have a different configuration or arrangement of systems or subsystems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device) and executed by one or more processors of the system 100.

In certain implementations, the system 100 may be implemented in a cloud environment using infrastructure provided by a cloud service provider (“CSP”). In such an embodiment, the functions performed by the observability system 100 and described in this disclosure may be offered via a cloud service to one or more customers subscribing to the cloud service. For example, either or both of the logs analysis system 110 and the observability system 150 may be offered as a cloud service to a customer. In some examples, a private instance, or tenancy, can be created for the customer in which some or all of the components of the system 100 may be isolated or otherwise configured for the exclusive use of the customer. For instance, the access management store 135 shown as a component of logs analysis system 110 may be a private instance of a database created for the exclusive use of a customer while the authentication subsystem 145 may be a component shared among numerous tenants.

The observability system 150 includes an observability data ingest system 155 that receives data from the monitored systems 105. For example, the observability data ingest system 155 can receive raw or pre-processed telemetry data from the monitored systems 105, including metrics, logs, or traces. In some examples, the observability data ingest system 155 can apply further pre-processing to received data prior to storing the received data in a suitable data store (not shown) to be used for generation of analytics, dashboards, reports, and so on.

The various operations that the observability system 150 can perform using the received data, as well as other associated functionality, are represented by the observability analysis subsystem 160. Example operations include charting, listing, statistical analysis of time-series data, profiling, or auto-correlation of metrics, among many others. The observability analysis subsystem 160 can provide access to the operations exposed as resources via a UI frontend such as a web application in concert with a web-based API. Alternatively, some client devices can access the observability analysis subsystem 160 directly using a web-based API.

In this context, a “resource” that can be accessed using an endpoint or API provided by the observability analysis subsystem 160 refers generally to one that first requires an authorization check. An authorization check refers generally to a process in which it is determined whether an authenticated user of the observability system 150 has permission to perform the operation. The permission may be referred to as a “capability” conferred on the user. Typically, an organizational administrator assigns capabilities to user consistently with their job role, job title, task requirements, or other criteria. These definitions are not intended to be limiting and are introduced here to facilitate the discussion of certain examples below. For example, the observability analysis subsystem 160 may be configured to perform composite or complex operations, some of which require authorization and some of which may not.

In a similar fashion, the logs analysis system 110 includes a logs data ingest subsystem 115 and a logs analysis subsystem 120. The logs data ingest subsystem 115 can receive raw data or pre-processed data from the monitored systems 105 and tasks such as parsing or initial processing of log streams. In analogy to the observability analysis subsystem 160, the logs analysis subsystem 120 can perform operations such as log analytics, text search, clustering, and statistical analysis, and so on, each of which may be accessed via a resource requiring an authorization for the requesting user. The logs analysis subsystem 120 can likewise provide access to the resources via a UI frontend such as a web application in concert with a web-based API. Alternatively, some client devices can access the logs analysis subsystem 120 directly using a web-based API. The UI and/or API used may be the same as the ones used by the observability analysis subsystem 160 or they may be different.

A user device 102 can access the logs analysis subsystem 120 and/or the observability analysis subsystem 160. The user device 102 can be any suitable device or computing system for accessing the logs analysis subsystem 120 and/or the observability analysis subsystem 160 such as a laptop, desktop, smartphone, tablet, etc. The user device 102 can be used, for example, to access a GUI or API provided by the logs analysis subsystem 120 and/or the observability analysis subsystem 160.

Before accessing any resources of the logs analysis system 110 or observability system 150, the user operating or associated with the user device 102 must authenticate itself. Authentication refers generally to a process of verifying the identity of a user that is attempting to access protected resources, typically by the presentation of credentials such as a key, password, token, or other secret known or possessed only by the respective client device.

The system 100 includes an authentication subsystem 145 that provides shared authentication services to the logs analysis system 110 and the observability system 150 and can be referred to as an SSO system. The authentication subsystem 145 is shown in FIG. 1 as included in the logs analysis system 110, as a component of the access management subsystem. The authentication subsystem 145 may be, for example, a first-or third-party identity provider that includes services for user authentication, credential storage, session management, access token validation, and so on. In some examples, the authentication subsystem 145 can be a standalone service that provides centralized authentication capabilities to both the logs analysis system 110 and observability system 150. In a typical authentication scenario, the user presents credentials (e.g., a password), which is validated by the authentication subsystem 145. The authentication subsystem 145 can return a token (e.g., an alphanumeric string including security information, digital signatures, etc.) that can be used by the user device 102 for subsequent requests to APIs provided by the logs analysis subsystem 120 and/or the observability analysis subsystem 160.

In some examples, the user can authenticate directly with the observability system 150 via a local authentication subsystem 162, shown as a component of the access management subsystem 165 of the observability system 150. The local authentication subsystem 162 can provide authentication services that are scoped solely to the observability subsystem 150. For example, a security token received following authentication to the local authentication subsystem 162 can be used to prove authentication to the observability analysis subsystem 160 but not the logs analysis subsystem 120. In some examples, when the local authentication subsystem 162 is used for authentication, authorization operations and associated may be similarly limited to the observability system 150, as described in more detail below. The local authentication subsystem 162 is shown using a dashed line to indicate that, in some examples, it may not be available or used once centralized authentication using SSO via the authentication subsystem 145 is enabled. In some cases, however, the local authentication subsystem 162 may be maintained as a legacy authentication operation to ensure continuity of services and access before it is disabled.

To access a resource provided by either the logs analysis subsystem 120 or the observability analysis subsystem 160 that includes one or more operations that require authorization, the user device 102 first sends information about the requested resource such as a Hypertext Transfer Protocol (“HTTP”) request to a web-based API provided by the logs analysis subsystem 120 or the observability analysis subsystem 160. The request can include authentication information for the user, such as an expirable security token.

Consider first an example involving the logs analysis subsystem 120. Upon receiving a request from an authenticated user that requires authorization, the logs analysis subsystem 120 can send a message to the authorization subsystem 140 that includes information about the requested resource or operations and information about the user, such as identifying information and the security token.

The authorization subsystem 140 may include components that can perform authorization checks. In a simple example involving an authorization check for a single operation, an authorization check can involve first determining the permissions or “capabilities” required for the operation. Then the capabilities associated with or assigned to the user can be determined. Finally, a check that the required capabilities are found among the assigned capabilities can be performed.

The information about the capabilities associated with or assigned to the user can be managed by the access management subsystem 125. The access management subsystem 125 includes components for creating, storing, editing, assigning, or retrieving capabilities. Capability information can be stored in the access management store 135. Capabilities can be grouped for administrative convenience into hierarchical groupings such as roles, with granular inheritance patterns and scope-based restrictions. A role may include a number of capabilities or nested collections of capabilities, to enable allocation of capabilities to control access based on criteria such as time of day, network location, job role or title, security clearance level, and so on. Role information can similarly be stored in the access management store 135. According to various examples, the access management store 135 can be implemented using a relational database system, a document-oriented database, or other suitable database type. The access management store 135 can be deployed as a component of the logs analysis system 110, locally or remotely, or using a cloud database service.

Roles and/or capabilities may be shared between the logs analysis system 110 and the observability system 150. For example, a role may include several capabilities specific for resources of the logs analysis system 110 and several that are specific for resources of the observability system 150. Likewise, a capability may be applicable to resources of both the logs analysis system 110 and the observability system 150. In some examples, roles or capabilities that are specific to one or the other system can be identified, for administrative convenience, using a prefix. For instance, a capability or role that is designated solely for use with the observability system 150 may be prefixed with “o11y_” or other suitable string.

Role and capability information can be created, edited, updated, deleted, and queried using an access management UI subsystem 130. The access management UI subsystem 130 can provide an administrative interface such as a web application for administrators to manage access control policies through editing of roles and/or capabilities assigned or associated with various client devices. The access management UI subsystem 130 can be accessed by an administrator device 132. Similarly to the user device 102, the administrator device 132 can be any suitable device or computing system for accessing the access management UI subsystem 130 such as a laptop, desktop, smartphone, tablet, etc.

In some examples, the access management subsystem 125 can provide authorization services for both the logs analysis system 110 and the observability system 150. For example, the observability analysis subsystem 160 can be communicatively coupled with the authorization subsystem 140, which can perform authorization checks for both the logs analysis subsystem 120 and the observability analysis subsystem 160. In this regard, roles and/or capabilities can be defined or “scoped” flexibly. For instance, roles or capabilities can be associated with resources included in the logs analysis subsystem 120, the observability analysis subsystem 160, or for both. Centralization of the storage and management of roles and capabilities can be a significant improvement to the user experience for administrators, particularly when SSO is in use to provide a unified login experience for the user. For example, administrators can use the access management UI subsystem 130 to manage roles and capabilities for both the logs analysis system 110 and the observability system 150 using a single interface and can share or maintain the independence of roles and capabilities as desired.

However, this configuration has many drawbacks. The coupling of the observability analysis subsystem 160 with the authorization subsystem 140 can introduce performance bottlenecks, as the centralization of authorization checks may result in increased latency and reduced system responsiveness, particularly under high-load conditions. Similarly, the requirement to contact the access management subsystem 125 for authorization of operations at the observability analysis subsystem constitutes a single point of failure that may reduce availability or reliability. The coupling between the logs analysis system 110 and the observability system, 150 can reduce modularity and increase difficulties relating to scalability and maintainability.

The techniques for cross-system resource authorization using user capabilities constitute an improved configuration that addresses these drawbacks. The observability system 150 includes an independent access management subsystem 165 with an independent authorization subsystem 170 that can perform authorization checks local to the observability system 150. The information for performing the authorization checks by the authorization subsystem 170 can be obtained by querying an authorization cache 175 that is periodically updated or updated in response to various triggering events with information stored in the access management store 135 of the logs analysis system 110.

The authorization cache 175 may be an in-memory or locally persisted data store configured to efficiently provide information about roles and capabilities obtained from the centralized access management store 135. The authorization cache 175 may be, for example, an in-memory key-value store, an object cache, a database query result cache, a database, or other suitable data store. For instance, the authorization cache 175 implemented as a key-value store may include role and capability information keyed to a unique identifier of the user (e.g., a unique device identifier created for the user or their respective user device 102 upon registration).

As mentioned above, while the information in the authorization cache 175 may be periodically updated or updated in response to various triggering events, it may likewise become stale or out of date. Consequently, the authorization cache 175 may be implemented using one or more retention policies. The retention policies can include criteria for expiring authorization cache 175 entries after a period of time has elapsed or when certain criteria are satisfied. For instance, the authorization cache 175 may expire cache entries that have not been for the last 10 minutes. In another example, the authorization cache 175 may be caused to expire cache entries in response to an update being made to stored information about the user using the access management UI subsystem 130. The cache retention policies 134 can be likewise configured by the administrator device 132 using the access management UI subsystem 130. The cache retention policies 134 may be, for example, a file according to a predetermined format (e.g., a JSON file) that includes information about the cache retention policies 134.

When the authorization cache 175 is queried for information that is absent or expired, the authorization cache 175 can be configured to attempt to retrieve the information from the access management store 135 via the centralized access management subsystem 125 (e.g., to refresh the cache). Thus refreshed, the information can be returned to the authorization subsystem 170 and the authorization check can proceed. The refreshed information is efficiently available for subsequent authorization checks.

In some examples, such as when authentication is effected using the local authentication subsystem 162, authorization checks can be similarly confined to the access management subsystem 165 in the observability system 150. In this case, the local access management store 180 may be used, similarly to the access management store 135. The local access management store 180 may, for example, include roles and/or capabilities that are limited in scope to the operations of the observability analysis subsystem 160.

For example, the logs analysis system 110 and the observability system 150 can use independent access management subsystems 125, 165, respectively, prior to enablement of SSO or centralized authorization. In that case, the respective access management stores 135, 180 may include roles and/or capabilities that are limited in scope to the operations of the respective analysis subsystems 120, 160.

Centralized authorization, in which persistent storage of roles and/or capabilities is transferred to the logs analysis system 110, can be enabled using a number of commands. For instance, the observability system 150 can receive a command from the administrator device 132 to cause the information about the roles and/or capabilities scoped to the observability system 150 stored in the local access management store 180 to be transferred or copied to the access management store 135 of the logs analysis system 110. This process can be referred to generally as “seeding” the access management store 135 of the logs analysis system 110. Alternatively or in addition, one or more default roles for the observability system 150 can be instantiated at the access management store 135, in which each default role has one or more associated default capabilities. For instance, when a new user is registered with the access management UI subsystem 130, and the new user is granted access to the observability system 150, the copied roles and/or the default roles can be assigned to the new user to grant access to observability resources.

While the examples shown in system 100 include a centralized authorization implementation including a logs analysis system 110 and an observability system 150, it should be appreciated that these are just examples and that the techniques for cross-system resource authorization using user capabilities are likewise applicable to various kinds of computing systems with authorization components. For example, the techniques can be used for centralized RBAC as between a video conference provider system and chat provider system operating in concert, in which one or the other system assumes a centralized authorization role.

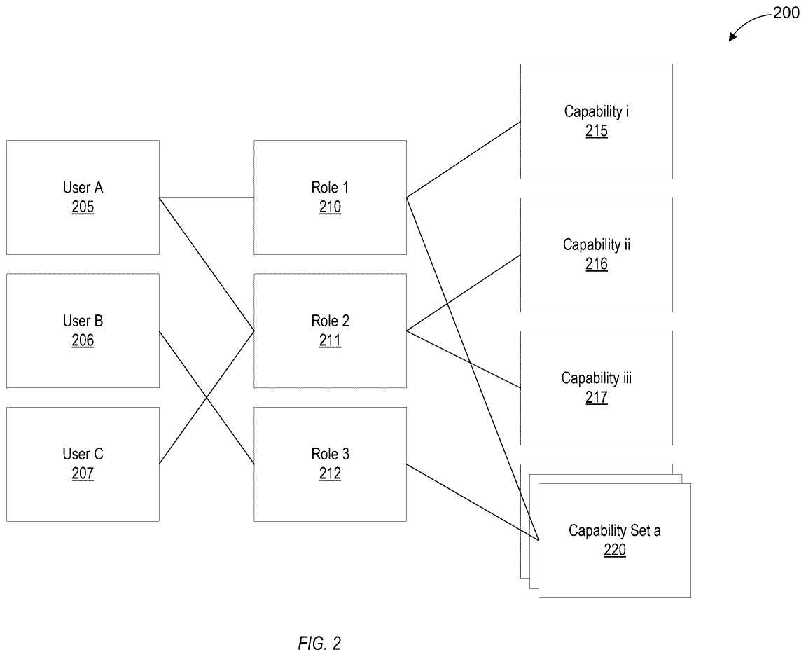

Turning next to FIG. 2, FIG. 2 shows an illustration 200 of a set of users, roles, and capabilities used with some systems for cross-system resource authorization using user capabilities, according to some examples of the present disclosure. Illustration 200 includes a set of users: user A 205, user B 206, and user C 207. In various examples, any number of users can be used with systems for cross-system resource authorization using user capabilities. Some systems may include hundreds, thousands, tens of thousands, or even more users. In the authentication and authorization context, users may refer generally to a digital entity identified by a digital identifier (e.g., a username, login id, email, etc.) that may not necessarily correspond to a physical person.

Each user may be assigned or associated with one or more roles. For example, the administrator device 132 can be used to assign roles to users using the access management UI subsystem 130. Illustration 200 shows a set of roles: role 1 210, role 2 211, and role 3 212. User A 205 is assigned to role 1 210 and role 2 211; user B 206 is assigned to role 3 212; and user C 207 is assigned to role 2 211. Roles may be named or otherwise identified with a functional grouping for administrative convenience. Examples of default roles used in some observability systems include an administrator role, a power user role, a read only role, or a user role. In various examples, any number of roles can be used with systems for cross-system resource authorization using user capabilities. Some systems may include hundreds, thousands, or even more roles.

Each role can be associated with one or more capabilities or permissions. Capabilities can correspond generally to permissions to perform certain actions, groups of actions, types of actions, or other characterization of action. Capabilities can operate at varying levels of granularity. For example, a capability can correspond to a narrow, limited permission to use a specific resource under certain circumstances, or it can correspond broadly to a class of resources and/or actions. Capabilities may be grouped into sets of capabilities for administrative ease, to enable efficient association with multiple roles. Nested sets of sets of capabilities can also be used. Capabilities can correspond to both functional and data access permissions. For example, capabilities can also include permissions to access certain resources such as database table or indexes, storage locations, hardware, network nodes, and so on.

Illustration 200 includes a set of capabilities or capability sets: capability i 215, capability ii 216, capability iii 217, and capability set a 220. Role 1 210 is associated with capability i 215 and capability set a 220; role 2 211 is associated with capability ii 216 and capability iii 217; and role 3 is associated with capability set a 220. In various examples, any number of capabilities can be used with systems for cross-system resource authorization using user capabilities. Some systems may include hundreds, thousands, or even more capabilities.

Illustration 200 shows the flexibility and efficiency of RBAC. An administrator need only associate user A 205 with role 1 210 and role 2 211 to grant user A with all configured capabilities. Likewise, the capabilities can be just as easily revoked by an administrator. This approach enables ease of management large, complex environments in particular.

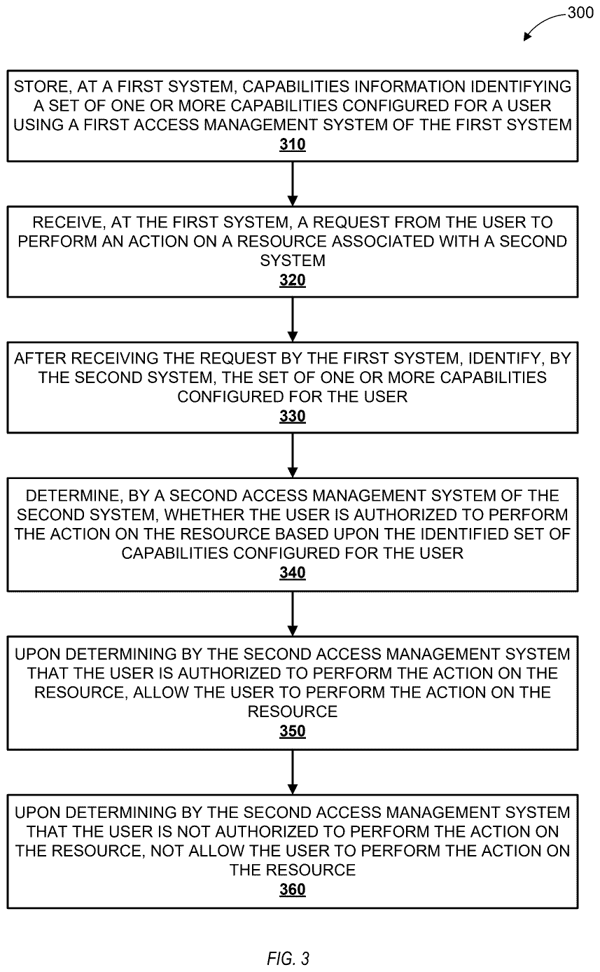

Referring now to FIG. 3, FIG. 3 shows a flowchart of an example method 300 for cross-system resource authorization using user capabilities, according to some examples of the present disclosure. The description of the method 300 in FIG. 3 will be made with reference to FIG. 1, however any suitable system according to this disclosure may be used. Other sequences of operations may also be performed according to alternative examples. For example, alternative examples of the present disclosure may perform the steps outlined above in a different order. Moreover, the individual operations illustrated by method 300 may include multiple sub-operations that may be performed in various sequences as appropriate to the individual operation. Furthermore, additional operations may be added or removed depending on the particular applications. Further, the operations described in method 300 may be performed by different devices. For example, the description is given from the perspective of the observability system 150 but other configurations are possible. One of ordinary skill in the art would recognize many variations, modifications, and alternatives.

The method 300 may include block 310. At block 310, a first system, such as the logs analysis system 110, stores capabilities information identifying a set of one or more capabilities configured for a user using a first access management system of the first system. Storage of the capabilities information at the first system may occur in response to, for example, determining that the observability system 150 has been configured to perform authorization operations using the authorization subsystem 140 included in the logs analysis system 110. In some examples, this determination can be made by checking the status of one or more feature flags. Feature flags can refer generally to variables (e.g., global or environment Boolean variables) that are set by system administrators that can be used by program code to determine the status of certain configurations.

Activation of the feature flag may correspond to a CSP customer opting in to a SSO solution or to centralized authorization services for the observability system 150. Determining the authorization configuration can further involve determining that the observability system 150 is configured to perform authorization operations using the access management system 125 of the logs analysis system 110. This configuration may be effected again using a feature flag. In some examples, authorization operations can be shifted to a centralized mode using a configuration interface provided by the access management UI subsystem 130.

Each user can be associated with one or more roles, and each role can be associated with one or more capabilities. In general, access to resources can be authorized based on association with required capabilities, roles, or both. In some examples, authorization can be based on required capabilities only. In that case, authorization checks may first involve converting any assigned roles to their associated capabilities to determine the required capabilities.

In some examples, a number of roles may be associated with the logs analysis system 110 and a number of roles may be associated with the observability system 150. Roles can likewise be shared between the logs analysis system 110 and the observability system 150. Similarly, capabilities can be scoped to the logs analysis system 110, the observability system 150, or shared between the two.

At block 320, a second system, such as the observability system 150, receives a request from the user to perform an action on a resource associated with the second system. For example, the user device 102 can output the request to the observability analysis subsystem 160 using a suitable UI such as a web application. The request may be, for instance, a request to generate a visualization using a specified database table or index. Alternatively, the request may be output to an API provided by the observability analysis subsystem 160 such as a web-based REST API.

In some examples, the user may be authenticated to both the first system and the second system using a single-sign-on (“SSO”) functionality. For example, the observability system 150 can receive information about an authentication by a user. The authentication may be performed by a remote authentication system such as an SSO system providing authentication services to a number of systems including the logs analysis system 110 and the observability system 150. For example, the user may authenticate to the authentication subsystem 145 configured to provide an SSO experience for both the logs analysis system 110 and the observability system 150. This operation may authenticate the user to the logs analysis system 110 and the observability system 150, but it does not equate to authorization to take any particular action for which separate authorization is required.

The user can provide a password, passkey, private encryption key, or other token or use a similar means for establishing its identity. In some examples, the user can authenticate solely to the observability system 150 using a local authentication subsystem 162. This may correspond to the case in which the observability system 150 is configured to perform authorization operations using the local authorization system 170. Use of SSO for authenticating to both the first and second systems may be a prerequisite configuration for to configure the second system to identify the capabilities configured users using the capabilities information stored at the first system.

At block 330, after receiving the request by the second system, the second system identifies the set of one or more capabilities configured for the user using the capabilities information stored by the first system. For example, the observability system 150 can obtain the capabilities information needed to authorize the user for the observability resource using an authorization cache (e.g., the authorization cache 175), where the authorization cache is populated by an access management system 125 of the logs analysis system 110 (e.g., access management subsystem 125), using the capabilities information stored as described in block 310.

The feature flags described in block 310 can be set to indicate that the observability system 150 is configured to perform authorization operations using the access management system 125 of the logs analysis system 110. In that case, the observability system 150 queries an authorization cache 175 using first information about the user, in which the authorization cache 175 includes second information about the capabilities associated with a number of client devices, the second information being periodically updated by the access management system 125 of the logs analysis system 110. For example, the observability analysis subsystem 160 can prepare and output a query to the authorization cache 175 including a unique reference to the user. The information in the authorization cache 175 can be periodically refreshed from the access management subsystem 125 or in response to certain triggers such as information in the access management store 135 being updated.

In some examples, the information is ephemerally stored in the authorization cache 175 according to a cache retention policy 134. For example, during initialization, the authorization cache 175 can receive information about role and capability retention, such as the cache retention policy 134 provided using the administrator device 132 during configuration of the access management subsystem 125. Later, during authorization operations, the authorization cache 175 can determine based on the information about role and capability retention, that information stored about one or more capabilities has expired, according to the durations specified in the cache retention policy 134. In that case, the authorization cache 175 can be configured to query the access management subsystem 125 using the identifying information about the user to receive updated information about the roles and/or capabilities associated with the user. The thus-retrieved information can be used to replacing or update the expired information about the user. A similar query to the access management subsystem 125 can be used to obtain authorization information for the user prior to authorization cache 175 population or when the information about the user is not present in the authorization cache 175 (e.g., the information has not yet been synced to the authorization cache 175).

In some examples, where the observability system 150 is instead configured to perform authorization operations using a local authorization system, the observability system 150 authorizes the user for the observability resource using a local authorization system. For example, the feature flags described in block 310 can be set to indicate that the observability system 150 is configured to perform authorization operations using the local authorization system. The authorization subsystem 170 of the observability system 150 can use information about roles and/or capabilities obtained from querying the local access management store 180 to perform an authorization check to authorize (or not) the request received in block 320.

In some examples, the information identifying the set of one or more capabilities configured for the user can be received by second system from the first system. For example, the authorization cache 175 may be out of date, not yet initialized, or offline. In that case, the first system can determine the set of one or more capabilities configured for the user and output the determined capabilities information to the authorization subsystem 170. In other words, capabilities information can be provided for both the first and second systems using the access management subsystem 125 of the first system 110. In this case, the capabilities information may be output in response to a request received by the first system from the second system requesting information indicative of capabilities configured for the user.

At block 340, a second access management system of the second system determines whether the user is authorized to perform the action on the resource based upon the identified set of capabilities configured for the user. For example, the authorization subsystem 170 of the observability system 150 can use information about roles and/or capabilities obtained from querying the authorization cache 175 to perform an authorization check to authorize (or not) the request received in block 320. The authorization cache 175 can be refreshed with role and capability information at system initialization, periodically, or upon updates to role or capability assignments. The set of required capabilities can be compared with the set of capabilities determined for each of the roles associated with the user. In some examples, all of the required capabilities must be included in the associated capabilities. In some other examples, only one of the required capabilities is required to be included among the associated capabilities.

At block 350, upon determining that the user is authorized to perform the action on the resource, the second access management system of the second system allows the user to perform the action on the resource. For example, the second access management system can output an indication to the user device 102 about the allowance. The indication may be access to the requested observability resource of the observability analysis subsystem 160. In some examples, the indication of the authorization may be first sent to the user device 102 in the form of an authorization token or other security token. The authorization token can then be presented to an API of the observability analysis subsystem 160 along with the appropriate authentication credentials or tokens to access the observability resource.

At block 360, upon determining that the user is not authorized to perform the action on the resource, the second access management system of the second system does not allow the user to perform the action on the resource. For example, the second access management system can output an indication to the user device 102 about the non-allowance. The indication may be a denial of access to the requested observability resource of the observability analysis subsystem 160. The denial of access may cause the user device 102 to display a suitable message to the user about the non-allowance.

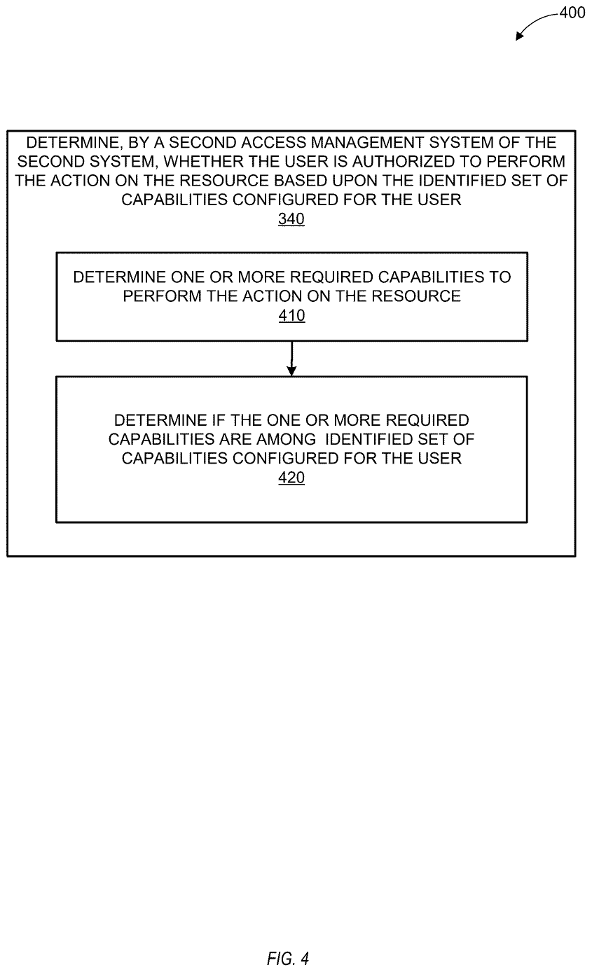

Referring now to FIG. 4, FIG. 4 shows a flowchart of an example method 400 for determining whether a user is authorized to perform an action on a resource based upon an identified set of capabilities configured for the user, according to some examples of the present disclosure. The description of the method 400 in FIG. 4 will be made with reference to FIG. 1, however any suitable system according to this disclosure may be used. Other sequences of operations may also be performed according to alternative examples. For example, alternative examples of the present disclosure may perform the steps outlined above in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices. For example, the description is given from the perspective of the observability system 150 but other configurations are possible. One of ordinary skill in the art would recognize many variations, modifications, and alternatives.

Method 400 includes additional detail for one example implementation of block 340 of FIG. 3 in which the observability system 150 determines whether the user is authorized to perform the action on the resource based upon the identified set of capabilities configured for the user. The method 400 may include block 410. At block 410, the observability system 150 determines one or more required capabilities for the observability resource. For example, a resource involving viewing a specific dashboard (e.g., for a particular monitored system) may require a specific capability created for that specific purpose. At a higher, more inclusive level, the resource may require a capability to view a particular class of dashboards (e.g., for all monitored systems in a particular network). At yet a higher level of inclusivity, the required capability may be to view all dashboards. Capabilities can be created with arbitrary levels of granularity and then grouped using capability sets and/or roles. Some observability resources may require more than one capability. For example, the view dashboard resource may require a capability to view that specific dashboard as well as a capability to access a particular monitored system or network.

At block 420, the observability system 150 determines if the one or more required capabilities are among identified set of capabilities configured for the user. The capabilities configured for the user can be determined, for example, from the authorization cache 175, one or more roles associated with the user. For example, the authorization cache 175 may be implemented as a key-value, in-memory store (e.g., Redis or memcache) that includes roles keyed to a unique identifying alphanumeric string associate with the user such as an IP address, MAC address, hostname, randomly or sequentially generated unique key, and so on. The authorization cache 175 can be queried using the key and the roles returned.

In some cases, the query may return no data, indicating that the particular user is not registered, not associated with any authorizations, or that the authorization cache 175 has not been populated or requires a refresh. In this case, the authorization cache 175 or the authorization subsystem 170 can be configured to attempt to retrieve the role information from the access management subsystem 125 of the logs analysis system 110. For example, the access management subsystem 125 may provide an API that can be queried using a similar keying strategy to the one described above. In cases in which the particular user is not registered or is not associated with any authorizations, the query may return an affirmative indication that the user is not authorized in contrast with the authorization cache 175 “miss” indicating that the data simply requires updating.

The observability system 150 can determine one or more capabilities allowed for the one or more roles. For example, the authorization cache 175 may further include capabilities along with roles. In some examples, the authorization cache 175 may be implemented as a relational database. In that case, the role information may again be keyed off a unique identifier of the user. The capability information for each role can be added to the query response using a table join to include the one or more capabilities associated with each role. In another example, the capabilities may be included in the authorization cache 175 when it is populated or refreshed. In yet another example, the capability information for each role can be obtained using a separate query to another API or local data store, although this approach may obviate some of the efficiency gains of using a fast authorization cache 175.

The set of required capabilities can be compared with the set of capabilities determined for each of the roles associated with the user. In some examples, all of the required capabilities must be included in the associated capabilities. In some other examples, only one of the required capabilities is required to be included among the associated capabilities. Once the determination of this block is complete, an indication of an authorization for accessing the observability resource can be output to the client and the user can be allowed to proceed with accessing the resource.

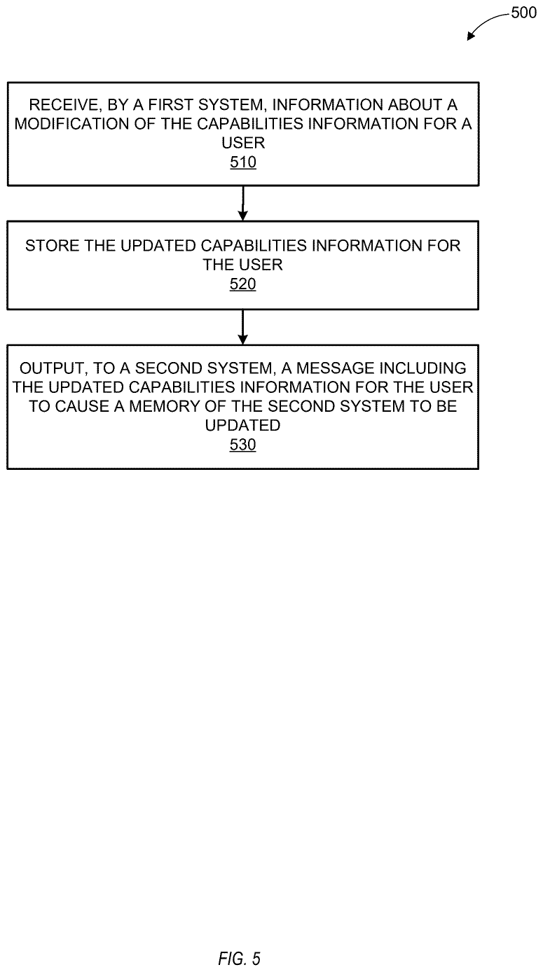

Referring now to FIG. 5, FIG. 5 shows a flowchart of an example method 500 for updating a memory of a second system by an access management system of a first system, according to some examples of the present disclosure. The description of the method 500 in FIG. 5 will be made with reference to FIG. 1, however any suitable system according to this disclosure may be used. Other sequences of operations may also be performed according to alternative examples. For example, alternative examples of the present disclosure may perform the steps outlined above in a different order. Moreover, the individual operations illustrated by method 500 may include multiple sub-operations that may be performed in various sequences as appropriate to the individual operation. Furthermore, additional operations may be added or removed depending on the particular applications. Further, the operations described in method 500 may be performed by different devices. For example, the description is given from the perspective of the logs analysis system 110 but other configurations are possible. One of ordinary skill in the art would recognize many variations, modifications, and alternatives.

The method 500 may include block 510. At block 510, a first system, such as the logs analysis system 110, receives information about a modification of the capabilities information for a user. For example, the administrator device 132 can interface with an access management UI subsystem 130 provided by the logs analysis system 110 (e.g., via a web application) to add, edit, or remove roles associated with the user. Alternatively, the administrator device 132 can add, edit, or remove capabilities associated with the user. In some examples, both roles and capabilities can be thus manipulated.

At block 520, the first system such as the logs analysis system 110, stores the updated capabilities information for the user. For example, the modification can be persisted in the access management store 135 associated with the logs analysis system 110 using, for example, a relational database INSERT or UPDATE SQL command or an UPSERT command typically used for document stores. The operation to store the updated role and/or capability information received in access management store 135 may be configured to cause the update operation in block 530 using, for example, a triggering mechanism provided by the access management store 135. For instance, a database “trigger” can automatically publish a change notification event to a message queue when role updates occur to enable downstream systems to react to changes to the access management store 135 as the occur.

At block 530, the first system such as the logs analysis system 110, outputs, to a second system, a message including the updated capabilities information for the user to cause a memory of the second system to be updated. The message may include information about the modification or may include a complete refresh of all role and capability information for the particular user. For example, using the triggering mechanism described above or upon detecting a change to the access management store 135 using a polling or monitoring mechanism, the message can be output to the authorization cache 175 along with a suitable command to cause the authorization cache 175 to update the cached information.

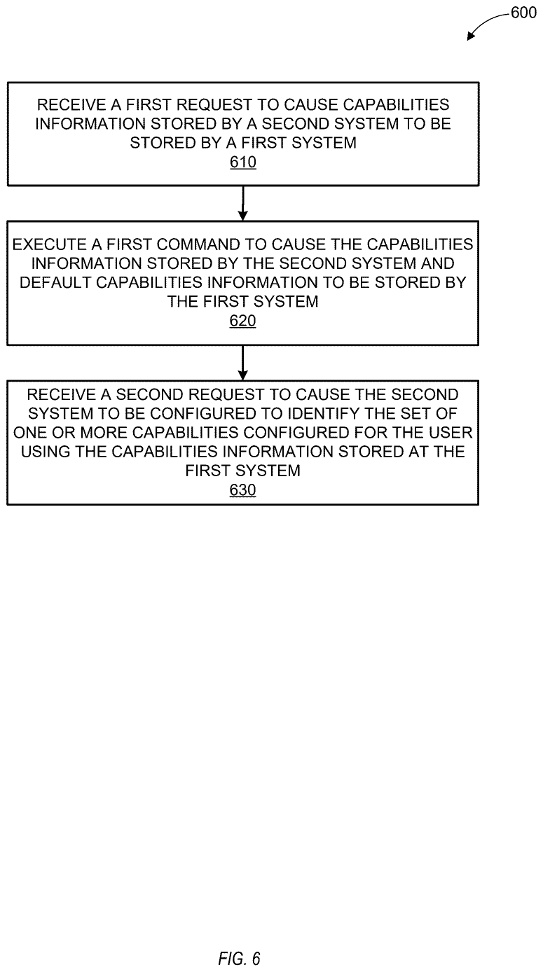

Referring now to FIG. 6, FIG. 6 shows a flowchart of an example method 600 for configuring authorization for a first system and second system, according to some examples of the present disclosure. The description of the method 600 in FIG. 6 will be made with reference to FIG. 1, however any suitable system according to this disclosure may be used. Other sequences of operations may also be performed according to alternative examples. For example, alternative examples of the present disclosure may perform the steps outlined above in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the perspective of the logs analysis system 110 but other configurations are possible. One of ordinary skill in the art would recognize many variations, modifications, and alternatives.

The method 600 may include block 610. At block 610, a first system such as a logs analysis system 110 receives a first request to cause capabilities information stored by a second system to be stored by a first system. The request may be receives from an administrator device 132. For example, the request may cause activation of a feature flag that may be set for a particular observability system 150 that has been operating as a standalone system to this point. For instance, a cloud tenant using services of a logs analysis system 110 and an observability system 150 may use the systems 110, 150 separately including separate authentication and authorization mechanisms. However, as described above, maintenance of parallel authorization systems has many challenges and drawbacks and thus the cloud tenant may desire to migrate to a centralized authorization system in which authorization using an RBAC scheme is managed by only one system (e.g., the logs analysis system 110). To enable this, the CSP can use a feature flag that can cause this method 600 to occur, including execution of instructions including the first command to cause a migration of the authorization information stored in the observability system 150 to the logs analysis system 110.

The feature flag may be implemented using environment variables, configuration files, feature flag management platforms, in-memory stores, distributed configuration systems, or database columns that can be toggled without requiring code deployment. In some examples, the feature flag can be set using a web-based API, such as by executing an HTTP POST request to a specified resource.

At block 620, the logs analysis system 110 executes a first command to cause the capabilities information stored by the second system and default capabilities information to be stored by the first system. For example, prior to setting of the feature flag, a number of existing roles and capabilities may be stored in the local access management store 180 of the observability system 150. In some examples, these existing roles and capabilities can be mirrored or copied to the access management store 135, thus becoming the default roles for the observability system 150.

In some examples, the default roles can be instantiated at the access management store 135 rather than copied. For example, the default roles for the observability system 150, created and stored in the access management store 135 during initialization may include at least one of an administrator role, a power user role, a read only role, or a user role. Likewise, each of these default roles can be associated with at least one of a capability, a capabilities group or set, or a resource access capability (e.g., permission to access a particular computing system or network). In this case, each of the registered client devices can be associated with at least one default role thus created.

At block 630, the logs analysis system 110 receives a second request to cause the second system to be configured to identify the set of one or more capabilities configured for the user using the capabilities information stored at the first system. For example, the second request can be again cause the setting of a suitable feature flag. Block 630 can follows block 620, in which the access management store 135 is initialized with observability system 150 roles and capability information. Prior to the execution of the second command, but after the access management store 135 is initialized with observability system 150 RBAC information, authorization operations by the observability system 150 may be proceeding using the authorization subsystem 170 and the local access management store 180. After the execution of the second command in this block, the authorization subsystem 170 can transition to using the authorization cache 175 as a source of RBAC information. The local access management store 180 may be no longer used, removed, or disconnected following this step.

The logs analysis system 110 can update, by the access management system 125 of the logs analysis system 110, an authorization cache included in the observability system 150. For example, the authorization cache 175 can be populated with the RBAC information in the access management store 135 applicable to authorization operations in the observability system 150. The initialization of the authorization cache 175 may involve executing a series of insertions or updates to the authorization cache 175 or execution of a batch operation or a series of batch operations to fully, initially populate the authorization cache 175. For instance, for an authorization cache 175 implemented using an in-memory key-value stored such as Redis, the Redis MSET command could be used to atomically write multiple key-value pairs in a single operation.

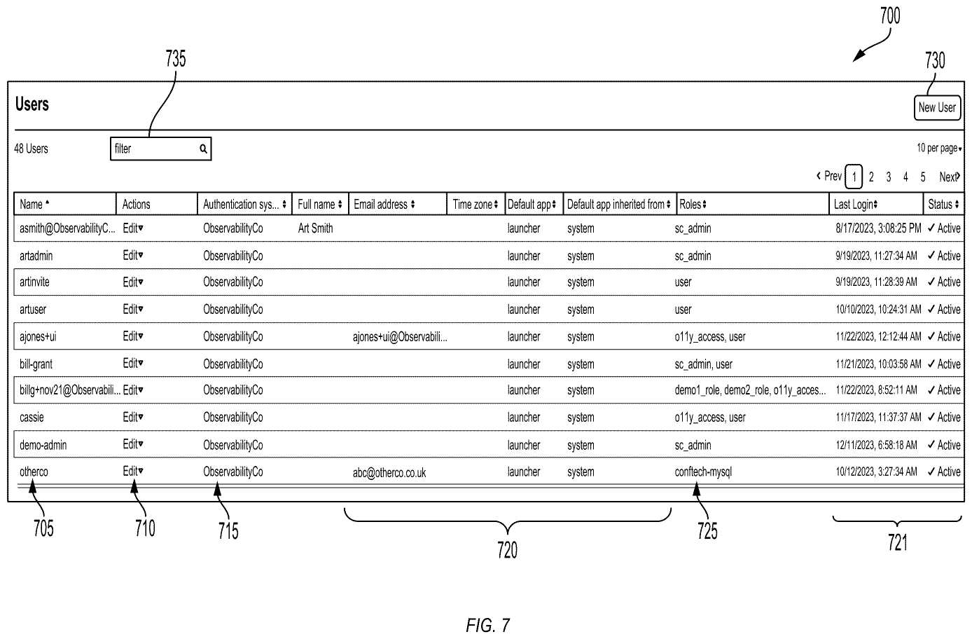

Turning next to FIG. 7, FIG. 7 shows an example of a GUI 700 for managing users for cross-system resource authorization using user capabilities, according to some examples of the present disclosure. The GUI 700 exemplifies an interface that may be provided by the access management UI subsystem 130 (e.g., as a web application) and accessed using the administrator device 132. The GUI 700 illustrates a resource for managing users including a display of information about assigned roles.

GUI 700 shows user information in a tabular presentation including usernames 705 for each user (or user device 102). The GUI 700 also includes a search input 735 that can be used to narrow the number of users shown through text filtering on the usernames 705. New users (or user device 102) records can be created by selecting the new user button 730.

Management operation selectors 710 are shown for each user which can be selected to edit or delete user information. The management operation selectors 710 may show different possible operations depending on the particular administrator using the GUI 700. Each user has a corresponding authorization system 715 shown, which may correspond to whether authorization operations are being handled by the logs analysis system 110, the observability system 150, or another system. Authorization operations can be transitioned as described above with respect to method 600 of FIG. 6. User demographic information 720, 721 is shown in each user row including data such as full username, email address, time zone, default application information, last login time, and activation status. Other user demographic information may be shown in addition to these examples.

Assigned user roles 725 are shown for each user as a comma separated list. The user roles 725 may be named in accordance with job title, job role, security clearance, etc. for administrative efficiency. User roles 725 may be associated with particular systems which can be indicated using, for example, an alphabetic prefix. In this example, roles associated with the logs analysis system 110 are prefixed with “sc_” and roles associated with the observability system 150 are prefixed with “o11y_”

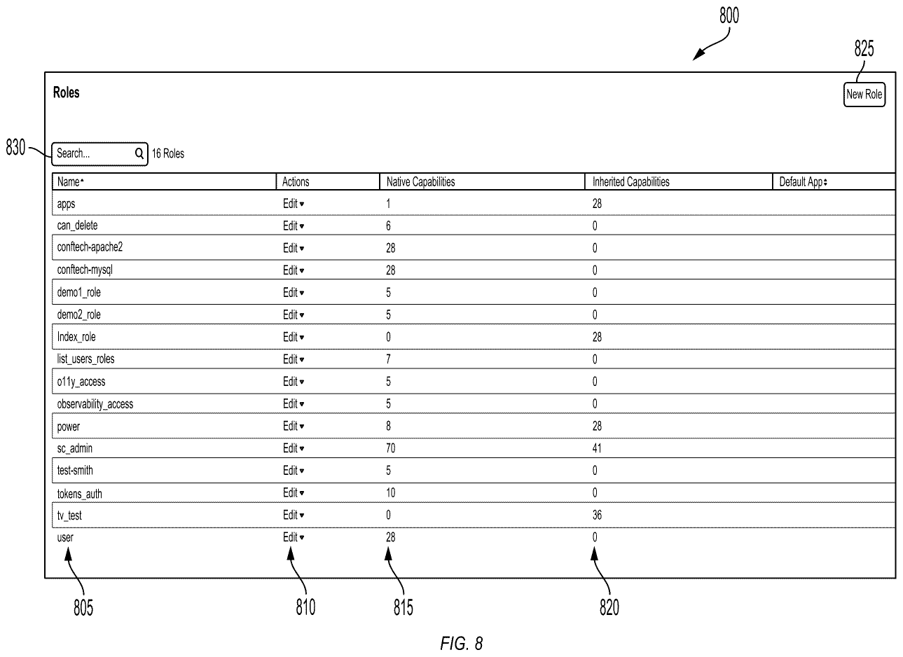

Turning next to FIG. 8, FIG. 8 shows an example of a GUI 800 for managing roles for cross-system resource authorization using user capabilities, according to some examples of the present disclosure. The GUI 800 again exemplifies an interface that may be provided by the access management UI subsystem 130 (e.g., as a web application) and accessed using the administrator device 132.

GUI 800 shows role information in a tabular presentation indexed by role names 805 for each respective role. As mentioned above, role names 805 may be associated with particular systems which can be indicated using, for example, an alphabetic prefix. In this example, roles associated with the logs analysis system 110 are prefixed with “sc_” and roles associated with the observability system 150 are prefixed with “o11y_” The role names 805 may include further semantic information about their intended use or configuration.

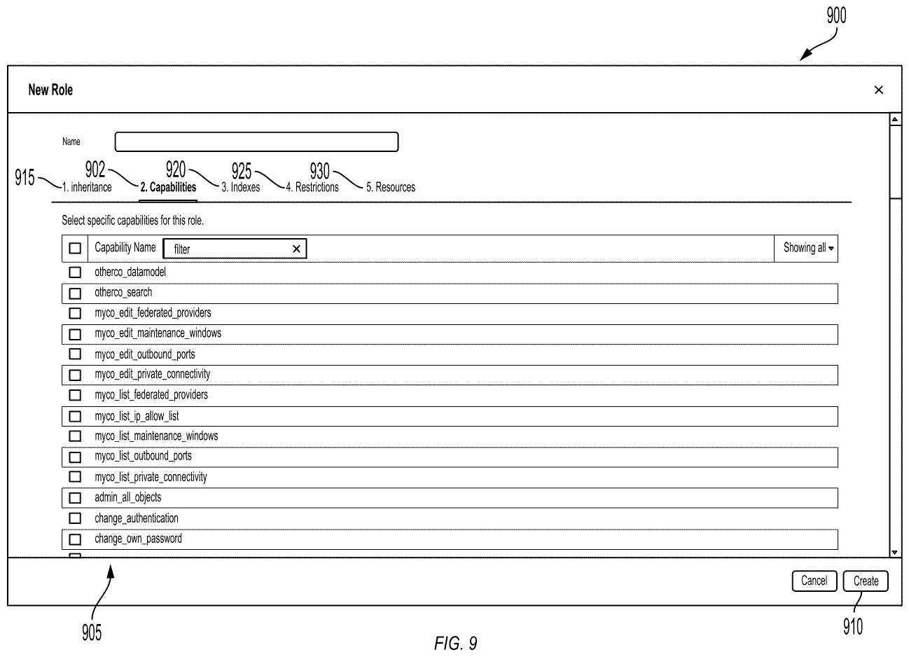

The GUI 800 also includes a search input 830 that can be used to narrow the number of roles shown through text filtering on the role names 805. New roles can be created by selecting the new role button 825. An example of a GUI for creating new roles is shown in FIG. 9 below.

Management operation selectors 810 are shown for each role which can be selected to edit or delete role information. The management operation selectors 810 may show different possible operations depending on the particular administrator using the GUI 800. Capability counts 815 are shown for each role. The capability counts 815 may correspond to the number of capabilities explicitly associated with each role. Inherited capability counts 820 are also shown for each role. In contrast to capability counts 815, the inherited capability counts 820 may correspond to capabilities implicitly included when a new role is created using another role as a basis. For example, a base “editor” role with certain capabilities can be created. Then a “resource editor” role can be created using the “editor” role as a basis. The “resource editor” role will inherit all configured capabilities of the “editor” role along with any new capabilities added to the “resource editor” role.

Turning next to FIG. 9, FIG. 9 shows an example of a GUI 900 for creating new roles for cross-system resource authorization using user capabilities, according to some examples of the present disclosure. The GUI 900 again exemplifies an interface that may be provided by the access management UI subsystem 130 (e.g., as a web application) and accessed using the administrator device 132.

The GUI 900 shows an interface that may be shown when the new role button 825 of FIG. 8 is selected. The GUI 900 shows a tabular presentation of capabilities 905 that may be associated with the new role. This example GUI 900 corresponds to the interface shown when the capabilities tab 902 is selected. New capabilities can be added using the create capability button 910. As with roles, capability names 905 may be associated with particular systems which can be indicated using, for example, an alphabetic prefix.

Additional interfaces for configured new roles may be shown according to different tab selections. Inheritance tab 915 can be used to select other roles to use as a basis for the new role, such that capabilities can be “inherited” as described above. The indexes tab 920 can be used to select certain resource access capabilities, such as access to certain databases or logs. The restrictions tab 925 can be used to select certain restrictions for the new role such as disallowed capabilities or resource access grants. The resources tab 930 can be used to select certain resource access capabilities, such as access to certain databases or logs, similarly to the indexes tab 920.

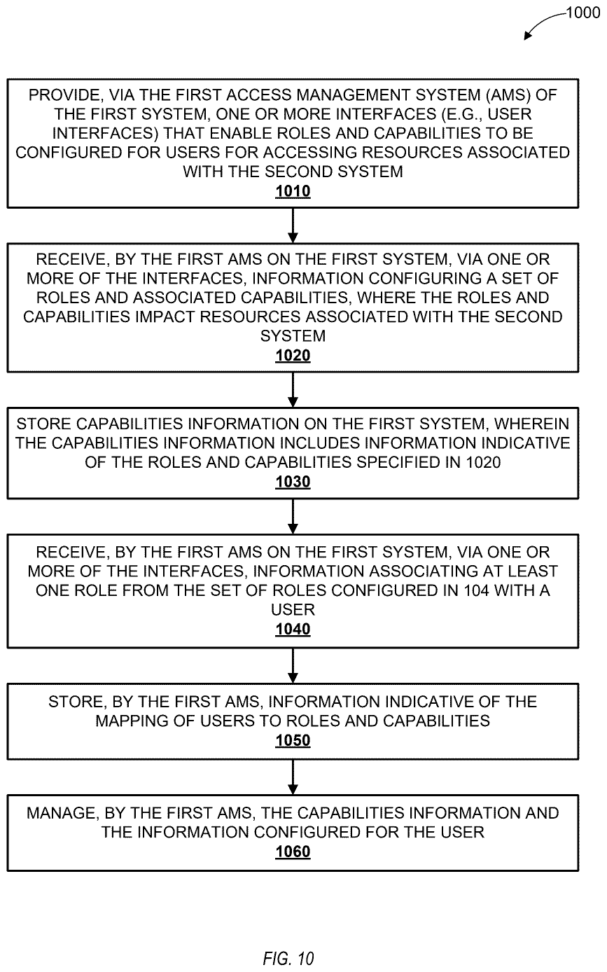

Referring now to FIG. 10, FIG. 10 shows a flowchart of an example method 1000 for managing capabilities information for cross-system resource authorization using user capabilities, according to some examples of the present disclosure. The description of the method 1000 in FIG. 10 will be made with reference to FIG. 1, however any suitable system according to this disclosure may be used. Other sequences of operations may also be performed according to alternative examples. For example, alternative examples of the present disclosure may perform the steps outlined above in a different order. Moreover, the individual operations illustrated by method 1000 may include multiple sub-operations that may be performed in various sequences as appropriate to the individual operation. Furthermore, additional operations may be added or removed depending on the particular applications. Further, the operations described in method 1000 may be performed by different devices. For example, the description is given from the perspective of the logs analysis system 150 but other configurations are possible. One of ordinary skill in the art would recognize many variations, modifications, and alternatives.

At block 1010, a first system provides, via a first access management system of the first system, one or more interfaces (e.g., user interfaces) that enable roles and capabilities to be configured for users for accessing resources associated with the second system. For example, the first access management system can be accessed using the administrator device 132 described in FIG. 1. The interface may be, for example, a web application or API provided by the first access management system.

At block 1020, the first system receives, by the first access management system on the first system, via one or more of the interfaces, information configuring a set of roles and associated capabilities, where the roles and capabilities impact resources associated with the second system. For example, the user interfaces exemplified in FIGS. 7-9 can be used to input information about newly created, updated, or deleted roles and capabilities.

At block 1030, the first system stores capabilities information on the first system, wherein the capabilities information includes information indicative of the roles and capabilities specified in 1020. For example, the access management store 135 can store the capabilities information using a suitable data format according to the particular type of database or file in use.

At block 1040, the first system receives, by the first access management system on the first system, via one or more of the interfaces, information associating at least one role from the set of roles configured in 1020 with a user. For example, the user interfaces exemplified in FIGS. 7-9 can be used to input information associating roles and/or capabilities with users.

At block 1050, the first system stores, by the first access management system of the first system, information indicative of the mapping of users to roles and capabilities. For example, the access management store 135 can again store the mapped capabilities information using a suitable data format according to the particular type of database or file in use.

At block 1060, the first system manages, by the first access management system, the capabilities information and the information configured for the user. For example, the first access management system can be used to provide, to the second system, a set of one or more capabilities configured for a user upon request. Likewise, the first access management system can be used to populate the authorization cache 175.

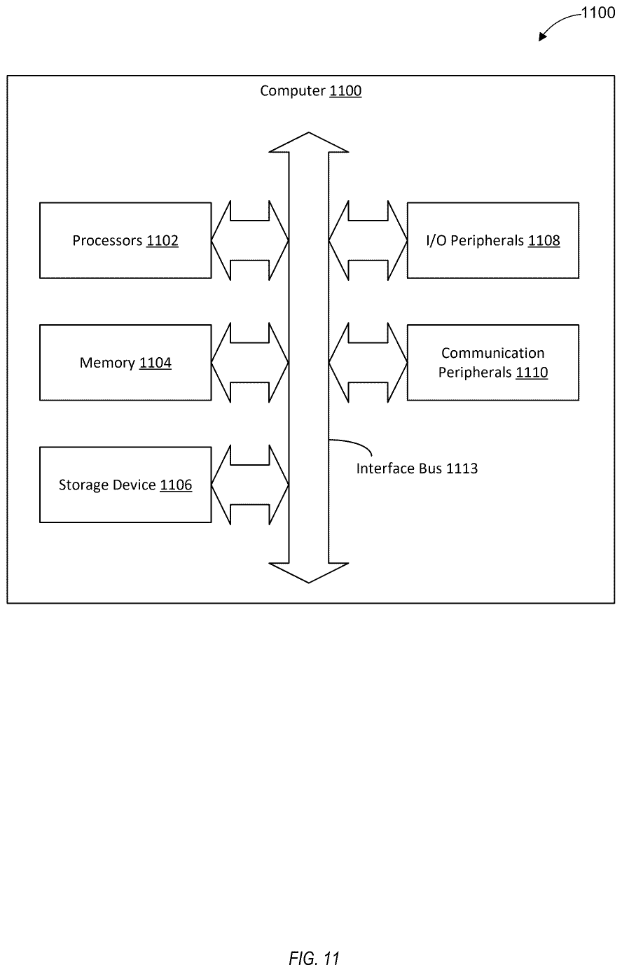

FIG. 11 illustrates an example of an architecture of a computer 1100 that may be used in some systems for cross-system resource authorization using user capabilities, according to some examples of the present disclosure. The computer 1100 includes at least processors 1102, a memory 1104, a storage device 1106, input/output peripherals (I/O) 1108, communication peripherals 1110, and an interface bus 1112. The interface bus 1112 is configured to communicate, transmit, and transfer data, controls, and commands among the various components of the computer 1100. The memory 1104 and the storage device 1106 include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such non-transitory computer readable storage media can be configured to store instructions or program codes embodying aspects of the disclosure. The memory 1104 and the storage device 1106 also include computer readable signal media. A computer readable signal medium includes a propagated data signal with computer readable program code embodied therein. Such a propagated signal takes any of a variety of forms including, but not limited to, electric, optical, or any combination thereof. A computer readable signal medium includes any computer readable medium that is not a computer readable storage medium and that can communicate, propagate, or transport a program for use in connection with the computer 1100.

Further, the memory 1104 includes an operating system, programs, and applications. The processors 1102 can include a controller. At least one of the processors 1102 is configured to execute the stored instructions and includes, for example, a logical processing unit, a microprocessor, a digital signal processor, and other processors. The I/O peripherals 1108 include user interfaces, such as a keyboard, screen (e.g., an electrophoretic panel with a panel controller), microphone, speaker, other input/output devices, and computing components, such as graphical processing units, serial ports, parallel ports, universal serial buses, and other input/output peripherals. The I/O peripherals 1108 are connected to the processor 1102 through any of the ports coupled to the interface bus 1112. The communication peripherals 1110 are configured to facilitate communication between the computer 1100 and other computers over a communication network and include, for example, a network interface controller, modem, wireless and wired interface cards, antenna, and other communication peripherals.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

These following illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method comprising: storing, at a first system, capabilities information identifying a set of one or more capabilities configured for a user using a first access management system of the first system; receiving, at a second system, a request from the user to perform an action on a resource associated with the second system; after receiving the request by the second system, identifying, by the second system, the set of one or more capabilities configured for the user using the capabilities information stored by the first system; determining, by a second access management system of the second system, whether the user is authorized to perform the action on the resource based upon the identified set of capabilities configured for the user; upon determining by the second access management system that the user is authorized to perform the action on the resource, allowing the user to perform the action on the resource; and upon determining by the second access management system that the user is not authorized to perform the action on the resource, not allowing the user to perform the action on the resource.

Example 2 is the method of example(s) 1, further comprising: caching the capabilities information in a memory of the second system; and wherein identifying, by the second system, the set of one or more capabilities configured for the user comprises using, by the second system, the capabilities information cached in the memory of the second system to identify the set of one or more capabilities configured for the user.

Example 3 is the method claim 2, further comprising: receiving, by the memory of the second system, information about capability information retention; determining, based on the information about capability information retention, that at least one capability configured for the user has expired; querying the first system by the second system for updated capability information about the at least one capability configured for the user; and replacing, in the memory of the second system, the at least one capability configured for the user with the updated capability information.

Example 4 is the method of example(s) 2, further comprising: receiving, by the memory of the second system, an update from the first system in response to a change to stored capabilities information.

Example 5 is the method of example(s) 1, further comprising: determining, by the first system and based upon the capabilities information stored by the first system, the set of one or more capabilities configured for the user; and wherein identifying, by the second system, the set of one or more capabilities configured for the user comprises receiving, by the second system from the first system, the information identifying the set of one or more capabilities configured for the user.

Example 6 is the method of example(s) 5, wherein determining the set of one or more capabilities configured for the user is performed responsive to a second request received by the first system from the second system requesting information indicative of capabilities configured for the user.

Example 7 is the method claim 1, wherein the capabilities information identifies a set of one or more roles configured for the user using the first access management system, wherein each role in the set of roles is associated with at least one capability from the set of capabilities.

Example 8 is the method of example(s) 1, further comprising: receiving, by the first system, a plurality of logs generated at a monitored system, each log in the plurality of logs comprising a record of one or more events or operations that occur at the monitors system; analyzing, by the first system, the plurality of logs to generate analysis results; outputting, by the first system, the analysis results; receiving, by the second system, observability data associated with the monitored system, the observability data comprising data gathered from monitoring of applications infrastructure, and users associated with the monitored system; analyzing, by the second system, the observability data to generate a set of metrics and dashboards; and outputting, by the second system, the set of metrics and dashboards.

Example 9 is the method of example(s) 1, wherein the user is authenticated to the first system and the second system using a single-sign-on functionality.

Example 10 is the method of example(s) 1, further comprising determining an authorization configuration for the second system, comprising: determining that the capabilities information is stored at the first system; and determining that the second system is configured to identify the set of one or more capabilities configured for the user using the capabilities information stored at the first system.

Example 11 is the method of example(s) 10, further comprising: receiving a first request to cause the capabilities information to be stored by the first system; and receiving a second request to cause the second system to be configured to identify the set of one or more capabilities configured for the user using the capabilities information stored at the first system.

Example 12 is the method of example(s) 11, wherein causing the capabilities information to be stored by the first system comprises: identifying first capabilities information stored by the second system; identifying default capabilities information associated with the second system, wherein the default capabilities information identifies a set of one or more default roles that can be configured for the user using the first access management system, wherein each default role in the set of default roles is associated with at least one default capability from a set of default capabilities; and executing a command to cause the first capabilities information and the default capabilities information to be stored by the first system.

Example 13 is a non-transitory computer-readable medium storing instructions that, when executed by one or more processors, cause the one or more processors to perform operations including: storing, at a first system, capabilities information identifying a set of one or more capabilities configured for a user using a first access management system of the first system; receiving, at a second system, a request from the user to perform an action on a resource associated with the second system; after receiving the request by the second system, identifying, by the second system, the set of one or more capabilities configured for the user using the capabilities information stored by the first system; determining, by a second access management system of the second system, whether the user is authorized to perform the action on the resource based upon the identified set of capabilities configured for the user; upon determining by the second access management system that the user is authorized to perform the action on the resource, allowing the user to perform the action on the resource; and upon determining by the second access management system that the user is not authorized to perform the action on the resource, not allowing the user to perform the action on the resource.

Example 14 is the non-transitory computer-readable medium of example(s) 13, further comprising additional instructions that, when executed by one or more processors, cause the one or more processors to perform operations including: caching the capabilities information in a memory of the second system; and wherein identifying, by the second system, the set of one or more capabilities configured for the user comprises using, by the second system, the capabilities information cached in the memory of the second system to identify the set of one or more capabilities configured for the user.

Example 15 is the non-transitory computer-readable medium of example(s) 13, further comprising additional instructions that, when executed by one or more processors, cause the one or more processors to perform operations including: determining, by the first system and based upon the capabilities information stored by the first system, the set of one or more capabilities configured for the user; and wherein identifying, by the second system, the set of one or more capabilities configured for the user comprises receiving, by the second system from the first system, the information identifying the set of one or more capabilities configured for the user.

Example 16 is the non-transitory computer-readable medium of example(s) 13, wherein the capabilities information identifies a set of one or more roles configured for the user using the first access management system, wherein each role in the set of roles is associated with at least one capability from the set of capabilities.

Example 17 is the non-transitory computer-readable medium of example(s) 13, further comprising additional instructions that, when executed by one or more processors, cause the one or more processors to perform operations including: receiving, by the first system, a plurality of logs generated at a monitored system, each log in the plurality of logs comprising a record of one or more events or operations that occur at the monitors system; analyzing, by the first system, the plurality of logs to generate analysis results; outputting, by the first system, the analysis results; receiving, by the second system, observability data associated with the monitored system, the observability data comprising data gathered from monitoring of applications infrastructure, and users associated with the monitored system; analyzing, by the second system, the observability data to generate a set of metrics and dashboards; and outputting, by the second system, the set of metrics and dashboards.

Example 18 is a system comprising: one or more processors; and one or more computer-readable storage media storing instructions which, when executed by the one or more processors, cause the one or more processors to perform operations including: storing, at a first system, capabilities information identifying a set of one or more capabilities configured for a user using a first access management system of the first system; receiving, at a second system, a request from the user to perform an action on a resource associated with the second system; after receiving the request by the second system, identifying, by the second system, the set of one or more capabilities configured for the user using the capabilities information stored by the first system; determining, by a second access management system of the second system, whether the user is authorized to perform the action on the resource based upon the identified set of capabilities configured for the user; upon determining by the second access management system that the user is authorized to perform the action on the resource, allowing the user to perform the action on the resource; and upon determining by the second access management system that the user is not authorized to perform the action on the resource, not allowing the user to perform the action on the resource.

Example 19 is the system of example(s) 18, further comprising additional instructions which, when executed by the one or more processors, cause the one or more processors to perform operations including: caching the capabilities information in a memory of the second system; and wherein identifying, by the second system, the set of one or more capabilities configured for the user comprises using, by the second system, the capabilities information cached in the memory of the second system to identify the set of one or more capabilities configured for the user.

Example 20 is the system of example(s) 18, further comprising additional instructions which, when executed by the one or more processors, cause the one or more processors to perform operations including: receiving, by the first system, a plurality of logs generated at a monitored system, each log in the plurality of logs comprising a record of one or more events or operations that occur at the monitors system; analyzing, by the first system, the plurality of logs to generate analysis results; outputting, by the first system, the analysis results; receiving, by the second system, observability data associated with the monitored system, the observability data comprising data gathered from monitoring of applications infrastructure, and users associated with the monitored system; analyzing, by the second system, the observability data to generate a set of metrics and dashboards; and outputting, by the second system, the set of metrics and dashboards.

That which is claimed is:

1. A method comprising:
storing, at a first system, capabilities information identifying a set of one or more capabilities configured for a user using a first access management system of the first system;
receiving, at a second system, a request from the user to perform an action on a resource associated with the second system;
after receiving the request by the second system, identifying, by the second system, the set of one or more capabilities configured for the user using the capabilities information stored by the first system;
determining, by a second access management system of the second system, whether the user is authorized to perform the action on the resource based upon the identified set of capabilities configured for the user;
upon determining by the second access management system that the user is authorized to perform the action on the resource, allowing the user to perform the action on the resource; and
upon determining by the second access management system that the user is not authorized to perform the action on the resource, not allowing the user to perform the action on the resource.

2. The method of claim 1, further comprising:
caching the capabilities information in a memory of the second system; and
wherein identifying, by the second system, the set of one or more capabilities configured for the user comprises using, by the second system, the capabilities information cached in the memory of the second system to identify the set of one or more capabilities configured for the user.

3. The method claim 2, further comprising:
receiving, by the memory of the second system, information about capability information retention;
determining, based on the information about capability information retention, that at least one capability configured for the user has expired;
querying the first system by the second system for updated capability information about the at least one capability configured for the user; and
replacing, in the memory of the second system, the at least one capability configured for the user with the updated capability information.

4. The method of claim 2, further comprising:
receiving, by the memory of the second system, an update from the first system in response to a change to stored capabilities information.

5. The method of claim 1, further comprising:
determining, by the first system and based upon the capabilities information stored by the first system, the set of one or more capabilities configured for the user; and
wherein identifying, by the second system, the set of one or more capabilities configured for the user comprises receiving, by the second system from the first system, the information identifying the set of one or more capabilities configured for the user.

6. The method of claim 5, wherein determining the set of one or more capabilities configured for the user is performed responsive to a second request received by the first system from the second system requesting information indicative of capabilities configured for the user.

7. The method claim 1, wherein the capabilities information identifies a set of one or more roles configured for the user using the first access management system, wherein each role in the set of roles is associated with at least one capability from the set of capabilities.

8. The method of claim 1, further comprising:
receiving, by the first system, a plurality of logs generated at a monitored system, each log in the plurality of logs comprising a record of one or more events or operations that occur at the monitors system;
analyzing, by the first system, the plurality of logs to generate analysis results;
outputting, by the first system, the analysis results;
receiving, by the second system, observability data associated with the monitored system, the observability data comprising data gathered from monitoring of applications infrastructure, and users associated with the monitored system;
analyzing, by the second system, the observability data to generate a set of metrics and dashboards; and
outputting, by the second system, the set of metrics and dashboards.

9. The method of claim 1, wherein the user is authenticated to the first system and the second system using a single-sign-on functionality.

10. The method of claim 1, further comprising determining an authorization configuration for the second system, comprising:
determining that the capabilities information is stored at the first system; and
determining that the second system is configured to identify the set of one or more capabilities configured for the user using the capabilities information stored at the first system.

11. The method of claim 10, further comprising:
receiving a first request to cause the capabilities information to be stored by the first system; and
receiving a second request to cause the second system to be configured to identify the set of one or more capabilities configured for the user using the capabilities information stored at the first system.

12. The method of claim 11, wherein causing the capabilities information to be stored by the first system comprises:
identifying first capabilities information stored by the second system;
identifying default capabilities information associated with the second system, wherein the default capabilities information identifies a set of one or more default roles that can be configured for the user using the first access management system, wherein each default role in the set of default roles is associated with at least one default capability from a set of default capabilities; and
executing a command to cause the first capabilities information and the default capabilities information to be stored by the first system.

13. A non-transitory computer-readable medium storing instructions that, when executed by one or more processors, cause the one or more processors to perform operations including:
storing, at a first system, capabilities information identifying a set of one or more capabilities configured for a user using a first access management system of the first system;
receiving, at a second system, a request from the user to perform an action on a resource associated with the second system;
after receiving the request by the second system, identifying, by the second system, the set of one or more capabilities configured for the user using the capabilities information stored by the first system;
determining, by a second access management system of the second system, whether the user is authorized to perform the action on the resource based upon the identified set of capabilities configured for the user;
upon determining by the second access management system that the user is authorized to perform the action on the resource, allowing the user to perform the action on the resource; and
upon determining by the second access management system that the user is not authorized to perform the action on the resource, not allowing the user to perform the action on the resource.

14. The non-transitory computer-readable medium of claim 13, further comprising additional instructions that, when executed by one or more processors, cause the one or more processors to perform operations including:
caching the capabilities information in a memory of the second system; and
wherein identifying, by the second system, the set of one or more capabilities configured for the user comprises using, by the second system, the capabilities information cached in the memory of the second system to identify the set of one or more capabilities configured for the user.

15. The non-transitory computer-readable medium of claim 13, further comprising additional instructions that, when executed by one or more processors, cause the one or more processors to perform operations including:
determining, by the first system and based upon the capabilities information stored by the first system, the set of one or more capabilities configured for the user; and
wherein identifying, by the second system, the set of one or more capabilities configured for the user comprises receiving, by the second system from the first system, the information identifying the set of one or more capabilities configured for the user.

16. The non-transitory computer-readable medium of claim 13, wherein the capabilities information identifies a set of one or more roles configured for the user using the first access management system, wherein each role in the set of roles is associated with at least one capability from the set of capabilities.

17. The non-transitory computer-readable medium of claim 13, further comprising additional instructions that, when executed by one or more processors, cause the one or more processors to perform operations including:
receiving, by the first system, a plurality of logs generated at a monitored system, each log in the plurality of logs comprising a record of one or more events or operations that occur at the monitors system;
analyzing, by the first system, the plurality of logs to generate analysis results;
outputting, by the first system, the analysis results;
receiving, by the second system, observability data associated with the monitored system, the observability data comprising data gathered from monitoring of applications infrastructure, and users associated with the monitored system;
analyzing, by the second system, the observability data to generate a set of metrics and dashboards; and
outputting, by the second system, the set of metrics and dashboards.

18. A system comprising:
one or more processors; and
one or more computer-readable storage media storing instructions which, when executed by the one or more processors, cause the one or more processors to perform operations including:
storing, at a first system, capabilities information identifying a set of one or more capabilities configured for a user using a first access management system of the first system;
receiving, at a second system, a request from the user to perform an action on a resource associated with the second system;
after receiving the request by the second system, identifying, by the second system, the set of one or more capabilities configured for the user using the capabilities information stored by the first system;
determining, by a second access management system of the second system, whether the user is authorized to perform the action on the resource based upon the identified set of capabilities configured for the user;
upon determining by the second access management system that the user is authorized to perform the action on the resource, allowing the user to perform the action on the resource; and
upon determining by the second access management system that the user is not authorized to perform the action on the resource, not allowing the user to perform the action on the resource.

19. The system of claim 18, further comprising additional instructions which, when executed by the one or more processors, cause the one or more processors to perform operations including:
caching the capabilities information in a memory of the second system; and
wherein identifying, by the second system, the set of one or more capabilities configured for the user comprises using, by the second system, the capabilities information cached in the memory of the second system to identify the set of one or more capabilities configured for the user.

20. The system of claim 18, further comprising additional instructions which, when executed by the one or more processors, cause the one or more processors to perform operations including:
receiving, by the first system, a plurality of logs generated at a monitored system, each log in the plurality of logs comprising a record of one or more events or operations that occur at the monitors system;
analyzing, by the first system, the plurality of logs to generate analysis results;
outputting, by the first system, the analysis results;
receiving, by the second system, observability data associated with the monitored system, the observability data comprising data gathered from monitoring of applications infrastructure, and users associated with the monitored system;
analyzing, by the second system, the observability data to generate a set of metrics and dashboards; and
outputting, by the second system, the set of metrics and dashboards.
